(19) United States
(12) Patent Application Publication
(10) Pub. No.: US 2026/0030778 A1
(43) Pub. Date: Jan. 29, 2026

(54) IMAGE PROCESSING METHOD, DEVICE, AND MEDIUM

(71) Applicant: Beijing Zitiao Network Technology Co., Ltd., Beijing (CN)

(72) Inventors: Zhuang JIA, Beijing (CN); Jiangfan DENG, Beijing (CN); Liying CHI, Beijing (CN); Xiang LONG, Beijing (CN); Kang DU, Beijing (CN)

(21) Appl. No.: 19/270,686

(22) Filed: Jul. 16, 2025

(30) Foreign Application Priority Data
Jul. 25, 2024 (CN) 202411009485.0

(51) Int. Cl. G06T 7/73; G06T 7/60

(52) U.S. Cl. CPC G06T 7/73; G06T 7/60; G06T 2207/20081; G06T 2207/20132; G06T 2207/30201

(57) ABSTRACT

The present disclosure provides an image processing method and apparatus, a device, a medium and a product. The method includes: first acquiring an eye image and a feature extraction result of the eye image; then determining a predicted position of a visible region of an eyeball, a predicted position of an entire region of an iris and a predicted position of an entire region of a pupil based on the feature extraction result; and then determining, based on these predicted positions, a predicted position of a visible region of the iris and a predicted position of a visible region of the pupil.

### CROSS-REFERENCE TO RELATED APPLICATION

The present application claims the priority to Chinese Patent Application No. 202411009485.0, filed on Jul. 25, 2024, the entire disclosure of which is incorporated herein by reference as portion of the present application.

### TECHNICAL FIELD

The present disclosure relates to an image processing method and apparatus, a device, a medium, and a product.

### BACKGROUND

For some scenarios, such as eye movement related scenarios like gaze estimation or eye tracking, there are needs of performing analysis on an eye image to obtain some content, such as a visible region of an eyeball, an entire region of a pupil, an entire region of an iris, a visible region of the pupil, and a visible region of the iris, so that eye movement related tasks can be performed subsequently based on such content.

However, how to acquire the above content has become an urgent technical problem to be solved.

### SUMMARY

The present disclosure provides an image processing method and apparatus, a device, a medium and a product.

To achieve the above object, the present disclosure provides the following technical solutions.

The present disclosure provides an image processing method, and the method includes:
acquiring an eye image and a feature extraction result of the eye image;
determining a predicted position of a visible region of an eyeball, a predicted position of an entire region of an iris and a predicted position of an entire region of a pupil based on the feature extraction result; and
determining a predicted position of a visible region of the iris and a predicted position of a visible region of the pupil based on the predicted position of the visible region of the eyeball, the predicted position of the entire region of the iris and the predicted position of the entire region of the pupil.

In one possible implementation, determining the predicted position of the entire region of the iris includes: determining an ellipse parameter of the entire region of the iris based on the feature extraction result; and determining the predicted position of the entire region of the iris based on the ellipse parameter.

In one possible implementation, determining the predicted position of the entire region of the pupil includes: determining an ellipse parameter of the entire region of the pupil based on the feature extraction result; and determining the predicted position of the entire region of the pupil based on the ellipse parameter.

In one possible implementation, determining the ellipse parameter of the entire region of the pupil includes: determining an ellipse parameter of the entire region of the iris based on the feature extraction result; determining a parameter of a minimum bounding square of the entire region of the iris based on the ellipse parameter of the entire region of the iris; cropping a region image of the minimum bounding square from the eye image based on the parameter of the minimum bounding square; and determining the ellipse parameter of the entire region of the pupil based on the region image.

In one possible implementation, the eye image is processed by a target model; the target model includes a feature extraction module, a first prediction module, a second prediction module, and a conditional joint module; the feature extraction module is configured to perform a feature extraction processing on the eye image to obtain the feature extraction result; the first prediction module is configured to determine the predicted position of the visible region of the eyeball based on the feature extraction result; the second prediction module is configured to determine the predicted position of the entire region of the iris and the predicted position of the entire region of the pupil based on the feature extraction result; and the conditional joint module is configured to determine the predicted position of the visible region of the iris and the predicted position of the visible region of the pupil based on the predicted position of the visible region of the eyeball, the predicted position of the entire region of the iris and the predicted position of the entire region of the pupil.

In a possible implementation, the method further includes: acquiring annotation information corresponding to the eye image, where the annotation information is used to describe an actual position of the visible region of the eyeball in the eye image, an actual position of the visible region of the iris in the eye image, and an actual position of the visible region of the pupil in the eye image; and updating the target model based on the predicted position of the visible region of the eyeball, the predicted position of the visible region of the iris, the predicted position of the visible region of the pupil, and the annotation information.

In one possible implementation, the annotation information includes an annotated position of the visible region of the eyeball, an annotated position of the visible region of the iris, and an annotated position of the visible region of the pupil;

the method further includes: determining a model loss based on a difference between the predicted position of the visible region of the eyeball and the annotated position of the visible region of the eyeball, a difference between the predicted position of the visible region of the iris and the annotated position of the visible region of the iris, and a difference between the predicted position of the visible region of the pupil and the annotated position of the visible region of the pupil; and

the updating the target model based on the predicted position of the visible region of the eyeball, the predicted position of the visible region of the iris, the predicted position of the visible region of the pupil, and the annotation information includes: updating the target model based on the model loss.

In one possible implementation, the second prediction module includes an iris parameter prediction network, an iris parameter conversion network, a pupil parameter prediction network, and a pupil parameter conversion network; the iris parameter prediction network is configured to predict an ellipse parameter of the entire region of the iris based on the feature extraction result; the iris parameter conversion network is configured to convert the ellipse parameter of the entire region of the iris into the predicted position of the entire region of the iris; the pupil parameter prediction network is configured to determine an ellipse parameter of the entire region of the pupil based on the feature extraction result; the pupil parameter conversion network is configured to convert the ellipse parameter of the entire region of the pupil into the predicted position of the entire region of the pupil; and
the updating the target model includes: updating the feature extraction module, the first prediction module, the iris parameter prediction network and the pupil parameter prediction network in the target model.

In one possible implementation, the predicted position includes a probability mask image and/or a binary mask image.

In one possible implementation, the predicted position of the visible region of the pupil is determined based on a product of the predicted position of the visible region of the eyeball and the predicted position of the entire region of the pupil; and the predicted position of the visible region of the iris is obtained based on a product of the predicted position of the visible region of the eyeball and the predicted position of the entire region of the iris.

The present disclosure further provides an image processing apparatus, which includes:
a data acquisition unit configured to obtain an eye image and a feature extraction result of the eye image;
a first determination unit configured to determine a predicted position of a visible region of an eyeball, a predicted position of an entire region of an iris and a predicted position of an entire region of a pupil based on the feature extraction result; and
a second determination unit configured to determine a predicted position of a visible region of the iris and a predicted position of a visible region of the pupil based on the predicted position of the visible region of the eyeball, the predicted position of the entire region of the iris and the predicted position of the entire region of the pupil.

The present disclosure further provides an electronic device. The device includes a processor and a memory; the memory is configured to store instructions or a computer program; and the processor is configured to execute the instructions or the computer program in the memory to enable the electronic device to perform the image processing method provided by the present disclosure.

The present disclosure further provides a computer-readable medium having instructions or a computer program stored therein which, when run on a device, enable the device to perform the image processing method provided by the present disclosure.

The present disclosure further provides a computer program product, which includes a computer program carried on a non-transitory computer-readable medium; and the computer program includes program code for performing the image processing method provided by the present disclosure.

### BRIEF DESCRIPTION OF DRAWINGS

In order to more clearly describe the technical solutions in the embodiments of the present disclosure or in the related art, the drawings for describing the embodiments or the related art will be briefly described below. Apparently, the drawings in the description below show merely some embodiments recited in the present disclosure, and those of ordinary skill in the art may still derive other drawings from these drawings without creative efforts.

FIG. 1 is a schematic diagram of an eye image provided by the embodiments of the present disclosure;

FIG. 2 is a flowchart of an image processing method provided by the embodiments of the present disclosure;

FIG. 3 is a schematic diagram of an analysis process provided by the embodiments of the present disclosure;

FIG. 4 is a schematic diagram of an analysis process provided by the embodiments of the present disclosure;

FIG. 5 is a schematic diagram of a mask image provided by the embodiments of the present disclosure;

FIG. 6 is a schematic diagram of a mask image provided by the embodiments of the present disclosure;

FIG. 7 is a schematic diagram of a mask image provided by the embodiments of the present disclosure;

FIG. 8 is a schematic diagram of a mask image provided by the embodiments of the present disclosure;

FIG. 9 is a schematic diagram of a mask image provided by the embodiments of the present disclosure;

FIG. 10 is a schematic diagram of a structure of an image processing apparatus provided by the embodiments of the present disclosure; and

FIG. 11 is a schematic diagram of a structure of an electronic device provided by the embodiments of the present disclosure.

### DETAILED DESCRIPTION

In order to facilitate the understanding of the technical solutions provided by the present disclosure, the following is a description of some technical terms.

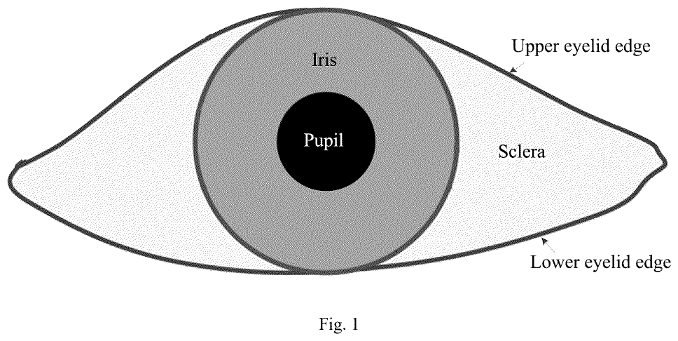

An eye image refers to an image that includes an eye, such as the image shown in FIG. 1; and the present disclosure does not limit the implementation of the eye image, for example, the eye image may be used to describe an eyeball, an eyelid, an eyebrow, etc. For another example, the eye image may further be used to describe some parts of a face other than the eye.

A visible region of an eyeball refers to a region present in the eye image and circled by an upper eyelid edge and a lower eyelid edge, so that the visible region of the eyeball can represent a portion of the eyeball that is not occluded by the eyelid, and thus the visible region of the eyeball can represent a portion of the eyeball that can receive light. In addition, the visible region of the eyeball may include a visible region of a sclera, a visible region of an iris, and a visible region of a pupil.

The visible region of the sclera refers to a region of the sclera that is present in the eyeball as described by the eye image and is not occluded by the eyelid, so that the visible region of the sclera can represent a portion of the sclera of the eyeball that can receive light.

The visible region of the iris refers to a region of the iris that is present in the eyeball as described by the eye image and is not occluded by the eyelid, so that the visible region of the iris can represent a portion of the iris of the eyeball that can receive light.

The visible region of the pupil refers to a region of the pupil that is present in the eyeball as described by the eye image and is not occluded by the eyelid, so that the visible region of the pupil can represent a portion of the pupil of the eyeball that can receive light.

An entire region of an iris refers to an elliptical region where the iris of the eyeball is located in the eye image, so that the entire region of the iris can represent a position of the complete iris in the eye image. In addition, the entire region of the iris includes the visible region of the iris and an invisible region of the iris. The invisible region of the iris refers to a region of the iris that is present in the eyeball as described by the eye image and is occluded by the eyelid, so that the invisible region of the iris can represent a portion of the iris of the eyeball that cannot receive light.

An entire region of a pupil refers to an elliptical region where the pupil of the eyeball is located in the eye image, so that the entire region of the pupil can represent a position of the complete pupil in the eye image. In addition, the entire region of the pupil includes the visible region of the pupil and an invisible region of the pupil. The invisible region of the pupil refers to a region of the pupil that is present in the eyeball as described by the eye image and is occluded by the eyelid, so that the invisible region of the pupil can represent a portion of the pupil of the eyeball that cannot receive light.

It has been found through research that when analyzing the eye image, due to the presence of eyelid occlusion in the eye image, the iris and/or the pupil are exposed in an incomplete manner, making it difficult to analyze a position of the entire region of the pupil and a position of the entire region of the iris, which makes the analysis process of the eye image difficult to achieve.

It has been further found through research that in some scenarios, segmentation techniques may be used to solve the difficulties in the preceding paragraph, and that a solution based on segmentation techniques includes: first, segmenting the eye image by taking the pupil, the iris, and the sclera as three different categories, to obtain a pupil segmentation mask, an iris segmentation mask and a sclera segmentation mask, such that the pupil segmentation mask is used to represent a position of the visible region of the pupil in the eye image, the iris segmentation mask is used to represent a position of the visible region of the iris in the eye image, and the sclera segmentation mask is used to represent a position of the visible region of the sclera in the eye image; then, using the pupil segmentation mask to perform ellipse fitting to obtain a position of the entire region of the pupil, and using the iris segmentation mask to perform ellipse fitting to obtain a position of the entire region of the iris.

It has been yet further found through research that the solution presented in the preceding paragraph suffers from the following defects: because the solution only satisfies a constraint, inherent to the eye itself, that the shape of the pupil and the shape of the iris are both elliptical, ignoring other constraints inherent to the eye itself, such as a constraint that “the iris is independent of the eyelid and the pupil is independent of the eyelid”, a constraint that “the eyelid may occlude the iris and/or the pupil”, and a constraint that “the occlusion of the eyelid may affect the shape of the visible region of the iris and the shape of the visible region of the pupil”, the position of the entire region of the pupil and the position of the entire region of the iris determined by the solution are inaccurate, and especially when the eye image is used to describe an eye in a partially closed state, the accuracy of the result determined by the solution is poor.

Based on the above research, in order to better improve accuracy, the present disclosure provides an image processing method. The method includes: first acquiring an eye image and a feature extraction result of the eye image, such that the feature extraction result can represent information carried by the eye image; then determining a predicted position of a visible region of an eyeball, a predicted position of an entire region of an iris and a predicted position of an entire region of a pupil based on the feature extraction result, so that the determination process satisfies at least a constraint, inherent to an eye itself, that the iris is independent of an eyelid and the pupil is independent of the eyelid; and then determining a predicted position of a visible region of the iris and a predicted position of a visible region of the pupil based on the predicted position of the visible region of the eyeball, the predicted position of the entire region of the iris and the predicted position of the entire region of the pupil, so that the determination process satisfies at least two constraints, inherent to the eye itself, that the eyelid may occlude the iris and/or the pupil, and that the occlusion of the eyelid may affect a shape of the visible region of the iris and a shape of the visible region of the pupil, which enables analysis of the eye image while satisfying all the constraints inherent to the eye itself as much as possible, thus effectively avoiding defects caused by ignoring some of the constraints inherent to the eye itself, thereby being beneficial to improving accuracy.

In addition, the present disclosure does not limit the execution entity of the image processing method provided by the embodiments of the present disclosure, for example, the image processing method provided by the embodiments of the present disclosure may be applied to a terminal device or a server. For another example, the image processing method provided by the embodiments of the present disclosure may also be implemented using a data interaction process between the terminal device and the server. Herein, the terminal device may be a smartphone, a computer, a personal digital assistant (PDA) or a tablet. The server may be a stand-alone server, a cluster server, or a cloud server.

For those skilled in the art to better understand the solutions of the present disclosure, the technical solutions in the embodiments of the present disclosure will be described below clearly and completely with reference to the drawings in the embodiments of the present disclosure. Apparently, the embodiments described are merely some rather than all of the embodiments of the present disclosure. All other embodiments obtained by those of ordinary skill in the art based on the embodiments of the present disclosure without creative efforts fall within the scope of protection of the present disclosure.

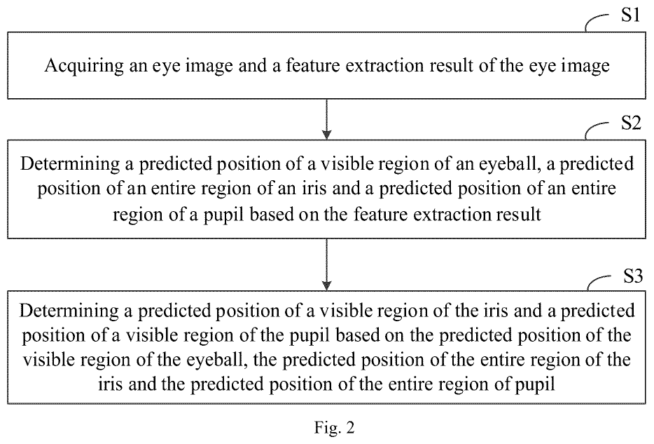

For a better understanding of the technical solutions provided by the present disclosure, the image processing method provided by the present disclosure is described below in conjunction with some drawings. As shown in FIG. 2, an image processing method provided by the embodiments of the present disclosure includes the following steps S1 to S3. FIG. 2 is a flowchart of an image processing method provided by the embodiments of the present disclosure.

S1: acquiring an eye image and a feature extraction result of the eye image.

The eye image is used to describe an eye.

In addition, the present disclosure does not limit the implementation of the eye image, for example, in some scenarios, the eye image may be implemented using any face image. A face image refers to an image used to describe characteristics of a face.

For another example, in some scenarios, the process of acquiring the eye image may include: first performing eye detection processing on a face image to obtain an eye position, so that the eye position is used to describe a position of the eye in the face image; then, cropping a region located at the eye position from the face image, to obtain a region image of the eye position, so that the region image is used to describe eye characteristics presented in the face image; and finally, determining the eye image based on the region image, which is beneficial to better prevent interference caused by parts of the face other than the eye, thereby being beneficial to improving accuracy.

It should be noted that the present disclosure does not limit the implementation of the step of “determining the eye image based on the region image” in the preceding paragraph, for example, in some scenarios, such as scenarios without size constraints, the step may include: directly determining the region image as the eye image. For another example, in some scenarios, such as scenarios with size constraints, if the size of the region image is not equal to a preset image size, the step may include: performing a size adjustment processing on the region image according to the preset image size to obtain an eye image, so that the size of the eye image is equal to the preset image size, such as a size of 128×128. The preset image size is used to represent image size requirements to be met in a current scenario, such as a scenario in which image processing is performed by a model.

Furthermore, for the eye image, the feature extraction result of the eye image is obtained by performing feature extraction processing on the eye image, so that the feature extraction result is used to describe information carried by the eye image; and the present disclosure does not limit the manner in which the feature extraction result is acquired, for example, it may be implemented using any existing or future feature extraction method.

For another example, in the case where the eye image is processed by a target model, the feature extraction result of the eye image may be determined using a feature extraction module in the target model.

The target model is used to perform an analysis processing on the eye image, such as to perform a position analysis processing on a visible region of an eyeball, an entire region of a pupil, an entire region of an iris, a visible region of the pupil, and a visible region of the iris; and the target model may include at least a feature extraction module.

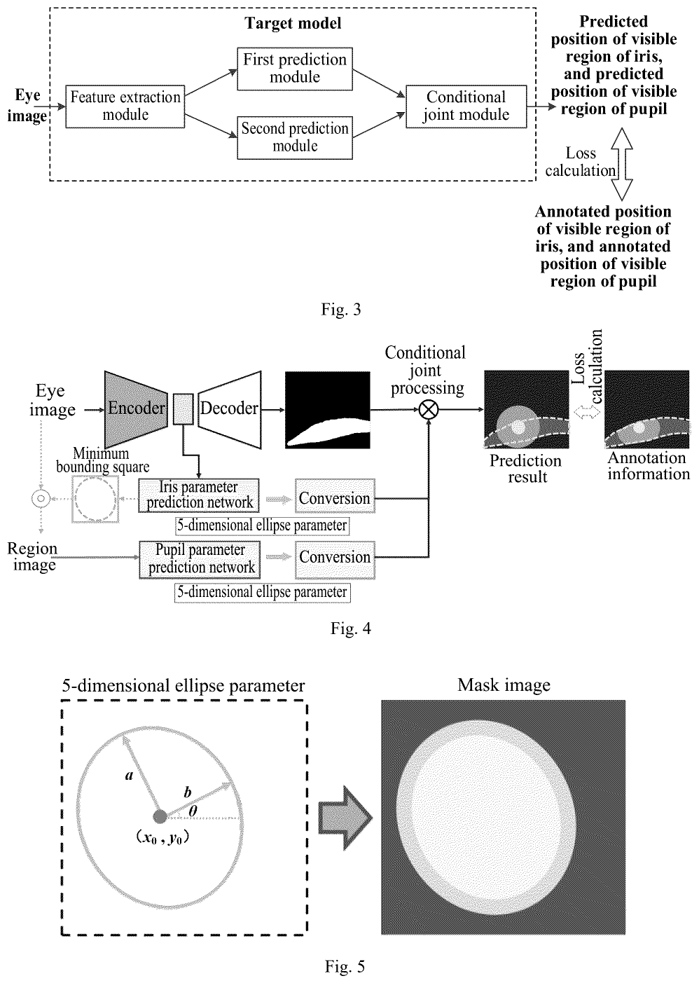

The feature extraction module is configured to perform a feature extraction processing on input data of the feature extraction module, such as the eye image; and the present disclosure does not limit the implementation of the feature extraction module, for example, the feature extraction module may be implemented using a feature extraction module shown in FIG. 3. For another example, the feature extraction module may be implemented using any existing or future encoder, such as the encoder shown in FIG. 4, or any autoencoder.

Based on the content related to S1 above, in some scenarios, when the eye image is processed by the target model, the eye image is acquired first; and the eye image is then input into the target model, so that the feature extraction module in the target model performs a feature extraction processing on the eye image to obtain the feature extraction result of the eye image, and thus the feature extraction result can better represent the information carried by the eye image, in order to be able to subsequently analyze, based on the feature extraction result, some characteristics of the eye described by the eye image.

S2: determining a predicted position of a visible region of an eyeball, a predicted position of an entire region of an iris and a predicted position of an entire region of a pupil based on the feature extraction result.

The predicted position of the visible region of the eyeball is used to describe a position where the visible region of the eyeball is predicted to be located in the eye image; and the present disclosure does not limit the implementation of the predicted position, for example, it may be implemented using any existing or future information that can represent a position of a region in an image, such as coordinates, detection boxes, and other information.

For another example, in order to better improve the accuracy of analysis, the present disclosure further provides one possible implementation of the predicted position of the visible region of the eyeball, in which the predicted position may be implemented using a probability mask image and/or a binary mask image. The probability mask image is used to describe a probability (or likelihood) that each pixel point in the eye image belongs to the visible region of the eyeball. The binary mask image is used to describe whether each pixel point in the eye image belongs to the visible region of the eyeball; and the binary mask image is obtained by performing certain processing (e.g., argmax processing) on the probability mask image.

It should be noted that, in the case where the eye image is processed by the target model, if the eye image is used in a training process of the target model, the predicted positions of respective regions determined by the target model may be implemented using the probability mask image in order to better improve the training effect of the model, which is beneficial to better guide the update and optimization of the target model; however, if the target model is used for an analysis task for the eye image, the predicted positions of the respective regions determined by the target model may be implemented using the binary mask image in order to better improve the accuracy of analysis.

In addition, the present disclosure does not limit the manner in which the predicted position of the visible region of the eyeball is acquired, for example, it may include: performing a segmentation processing based on the feature extraction result, to obtain the predicted position of the visible region of the eyeball.

Furthermore, the present disclosure does not limit the implementation of the segmentation processing in the preceding paragraph, for example, it may be implemented using any existing or future segmentation method.

For another example, in the case where the eye image is processed by the target model, the predicted position of the visible region of the eyeball may be determined using a first prediction module in the target model. Input data of the first prediction module includes output data of the feature extraction module in the target model; and the first prediction module is configured to determine the predicted position of the visible region of the eyeball based on the input data, such as the feature extraction result of the eye image.

Furthermore, the present disclosure does not limit the implementation of the first prediction module, for example, the first prediction module may be configured to perform a segmentation processing based on the feature extraction result of the eye image to obtain the predicted position of the visible region of the eyeball, such as the mask image of the visible region of the eyeball as shown in FIG. 4. For another example, the first prediction module may be implemented using the first prediction module shown in FIG. 3. For yet another example, that first prediction module may be implemented using any existing or future detection head, such as the decoder shown in FIG. 4.

The predicted position of the entire region of the iris is used to describe a position where the entire region of the iris is predicted to be located in the eye image; and the present disclosure does not limit the implementation of the predicted position, for example, the predicted position is similar to the implementation of “the predicted position of the visible region of the eyeball” above. In one possible implementation, the predicted position of the entire region of the iris may be implemented using the probability mask image and/or the binary mask image.

In addition, in order to better improve the accuracy of analysis, the present disclosure provides a way of determining the predicted position of the entire region of the iris, in which the process of determining the predicted position of the entire region of the iris may include step 11 and step 12 as follows.

Step 11: determining an ellipse parameter of the entire region of the iris based on the feature extraction result of the eye image.

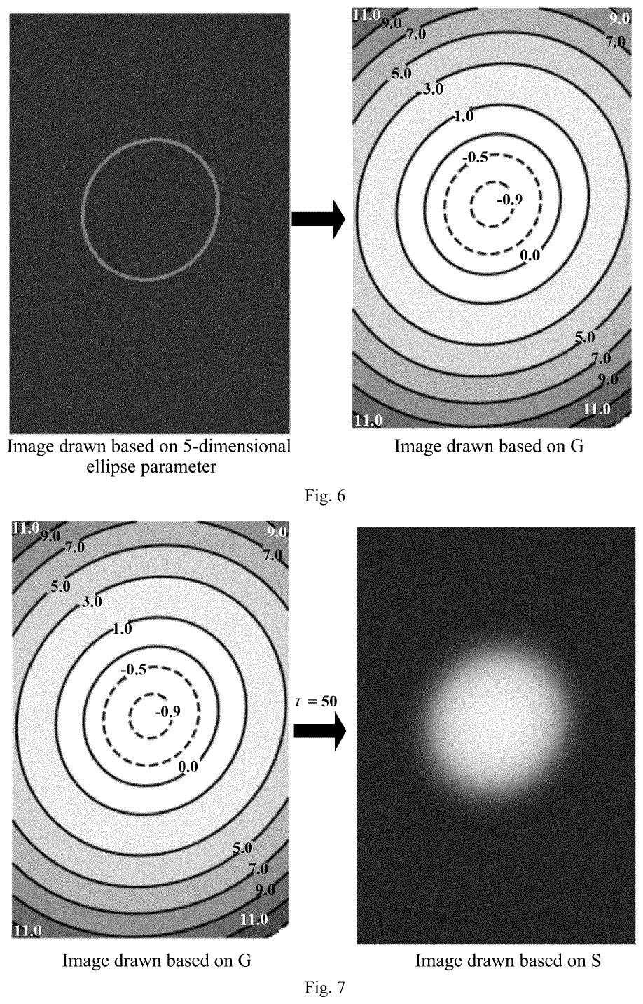

The ellipse parameter of the entire region of the iris is used to describe an ellipse formed by the entire region of the iris, such as the ellipse shown by the left image in FIG. 5 or the ellipse shown by the left image in FIG. 6, so that the ellipse parameter can represent a boundary position of the entire region of the iris.

It should be noted that the present disclosure does not limit the implementation of the ellipse parameter, for example, the ellipse parameter may be implemented using a 5-dimensional ellipse parameter (x₀, y₀, a, b, θ). (x₀, y₀) represents coordinates of the center of the ellipse; a represents the length of the semi-major axis of the ellipse; b represents the length of the semi-minor axis of the ellipse; θ represents a rotation angle of the ellipse, such as the angle between the semi-major axis of the ellipse and the horizontal axis in the coordinate system (or the angle between the semi-minor axis of the ellipse and the horizontal axis in the coordinate system).

In addition, in the case where the eye image is processed by the target model, the ellipse parameter of the entire region of the iris may be determined using an iris parameter prediction network in the target model. Input data of the iris parameter prediction network includes the output data of the feature extraction module in the target model; and the iris parameter prediction network is configured to predict the ellipse parameter of the entire region of the iris based on the input data, such as the feature extraction result of the eye image.

In addition, the present disclosure does not limit the implementation of the iris parameter prediction network, for example, the iris parameter prediction network may be implemented using a regression network, or other networks used to achieve a prediction function, which the present disclosure does not limit.

Furthermore, in order to better improve accuracy, the present disclosure further provides one possible implementation of step 11 mentioned above, in which step 11 may include step 111 and step 112 as follows in the case where the eye image is processed by the target model.

Step 111: predicting, by the iris parameter prediction network in the target model, a relative parameter (\hat{x}₀₍ᵢ₎, ŷ₀₍ᵢ₎, â₍ᵢ₎, \hat{b}₍ᵢ₎, \hat{θ}₍ᵢ₎) of the entire region of the iris on the eye image based on the feature extraction result of the eye image, so that the relative parameter can represent a relative position of the ellipse described by the entire region of the iris in the eye image. \hat{x}₀₍ᵢ₎ is used to represent a ratio, such as a percentage, of the horizontal coordinate of the ellipse center of the ellipse to the width w of the eye image; ŷ₀₍ᵢ₎ is used to represent a ratio of the vertical coordinate of the ellipse center of the ellipse to the height h of the eye image; â₍ᵢ₎ is used to represent a ratio of the length of the semi-major axis of the ellipse to min(w, h)/2; \hat{b}₍ᵢ₎ is used to represent a ratio of the length of the semi-minor axis of the ellipse to min(w, h)/2; and \hat{θ}₍ᵢ₎ represents the relative rotation angle at which the ellipse is in the eye image, such as the angle between the semi-major axis of the ellipse and the horizontal axis in the coordinate system of the eye image (or the angle between the semi-minor axis of the ellipse and the horizontal axis in the coordinate system).

Step 112: processing, by a first processing module in the target model, the relative parameter of the entire region of the iris on the eye image based on size information of the eye image, to obtain the ellipse parameter (x₀₍ᵢ₎, y₀₍ᵢ₎, a₍ᵢ₎, b₍ᵢ₎, θ₍ᵢ₎) of the entire region of the iris, so that the ellipse parameter can represent the position of the ellipse described by the entire region of the iris in the eye image.

It should be noted that the present disclosure does not limit the implementation of step 112, for example, it may be implemented using any existing or future method that can determine absolute information based on relative information.

For another example, in order to better improve accuracy, step 112 mentioned above may be implemented using formulas (1) to (5) below.

$${x}_{0 ( i )} = {\hat{x}}_{0 ( i )} \times w \qquad ( 1 )$$

$${y}_{0 ( i )} = {\hat{y}}_{0 ( i )} \times h \qquad ( 2 )$$

$${a}_{( i )} = ( {\hat{a}}_{( i )} + ε ) \times min ( w , h ) / 2 \qquad ( 3 )$$

$${b}_{( i )} = ( {\hat{b}}_{( i )} + ε ) \times min ( w , h ) / 2 \qquad ( 4 )$$

$${θ}_{( i )} = {\hat{θ}}_{( i )} \qquad ( 5 )$$

where x₀₍ᵢ₎ represents the horizontal coordinate of the ellipse center of the ellipse described by the entire region of the iris; w represents the width of the eye image; \hat{x}₀₍ᵢ₎ represents the ratio, such as a percentage, of the horizontal coordinate of the ellipse center to the width; y₀₍ᵢ₎ represents the vertical coordinate of the ellipse center of the ellipse; h represents the height of the eye image; ŷ₀₍ᵢ₎ represents the ratio, such as a percentage, of the vertical coordinate of the ellipse center to the height; a₍ᵢ₎ represents the length of the semi-major axis of the ellipse; â₍ᵢ₎ represents the ratio of the length of the semi-major axis of the ellipse to min(w, h)/2; b₍ᵢ₎ represents the length of the semi-minor axis of the ellipse; \hat{b}₍ᵢ₎ represents the ratio of the length of the semi-minor axis of the ellipse to min(w, h)/2; ε is a very small value set in advance based on the actual application scenario, so that the present disclosure can use ε to limit the length of the semi-major axis or the length of the semi-minor axis of the ellipse to not be less than a preset value, which is beneficial to ensure that problems caused by â₍ᵢ₎ or \hat{b}₍ᵢ₎ being close to 0 or even equal to 0, such as calculation errors when using a₍ᵢ₎ or b₍ᵢ₎ as a denominator, can be avoided; θ₍ᵢ₎ represents the rotation angle of the ellipse; and \hat{θ}₍ᵢ₎ represents the relative rotation angle at which the ellipse is in the eye image.

Input data of the first processing module includes output data of the iris parameter prediction network in the target model; and the first processing module is configured to process the output data according to the above formulas (1) to (5). It should be noted that the present disclosure does not limit the implementation of the first processing module, for example, it may be implemented using any existing or future network or module that can implement formulas (1) to (5).

Based on the content related to step 111 and step 112 mentioned above, in some scenarios, if the output data of the iris parameter prediction network in the target model is used to represent relative information, such as ratios, on the eye image, the output data of the iris parameter prediction network may be processed by the first processing module in the target model to obtain the ellipse parameter of the entire region of the iris, so that the ellipse parameter can represent the position of the ellipse described by the entire region of the iris in the eye image, which is beneficial to better improve the analysis effect.

Step 12: determining the predicted position of the entire region of the iris based on the ellipse parameter of the entire region of the iris.

It should be noted that the implementation of step 12 mentioned above of the present disclosure, for example, step 12 may include: determining the ellipse parameter of the entire region of the iris as the predicted position of the entire region of the iris.

For another example, in some scenarios, such as scenarios where an image is processed by a model, in order to better improve the analysis effect, the predicted position of the entire region of the iris may be implemented using a mask image. Therefore, to meet this requirement, step 12 may include: converting the ellipse parameter of the entire region of the iris into a mask image, to obtain the predicted position of the entire region of the iris.

In addition, the present disclosure does not limit the implementation of the conversion in the preceding paragraph, for example, it may be implemented using a predefined formula or a mapping rule.

It has been found through research that an ellipse can be represented by the standard elliptic equation presented in formula (6) below or by the binary quadratic equation presented in formula (7) below, and it can be deduced, based on the two formulas, that relationships existing between the two formulas include those presented in formulas (8) to (13) below.

$$\frac{{[ ( x - {x}_{0} ) cos θ + ( y - {y}_{0} ) sin θ ]}^{2}}{{a}^{2}} + \frac{{[ - ( x - {x}_{0} ) sin θ + ( y - {y}_{0} ) cos θ ]}^{2}}{{b}^{2}} = 1 \qquad ( 6 )$$

$$A {x}^{2} + B x y + C {y}^{2} + D x + E y + F = 0 , A \neq 0 , B \neq 0 , C \neq 0 \qquad ( 7 )$$

$$A = \frac{{sin}^{2} θ}{{b}^{2}} + \frac{{cos}^{2} θ}{{a}^{2}} \qquad ( 8 )$$

$$B = 2 ( \frac{1}{{a}^{2}} - \frac{1}{{b}^{2}} ) sin θ cos θ \qquad ( 9 )$$

$$C = \frac{{cos}^{2} θ}{{b}^{2}} + \frac{{sin}^{2} θ}{{a}^{2}} \qquad ( 10 )$$

$$D = - 2 A {x}_{0} - B {y}_{0} \qquad ( 11 )$$

$$E = - B {x}_{0} - 2 C {y}_{0} \qquad ( 12 )$$

$$F = - \frac{D {x}_{0} + E {y}_{0}}{2} - 1 \qquad ( 13 )$$

where (x₀, y₀, a, b, θ) represents an ellipse parameter of an ellipse; (x₀, y₀) represents the coordinates of the ellipse center of the ellipse; a represents the length of the semi-major axis of the ellipse; b represents the length of the semi-minor axis of the ellipse; and 0 represents the rotation angle of the ellipse, while (x, y) is any point on the ellipse.

It has been further found through research that further derivation based on the above formulas (6) to (13) leads to the following conclusion: the ellipse can be expressed as presented in formulas (14) to (16) below.

$${X}^{T} M X = 0 \qquad ( 14 )$$

$$X = [ x , y , 1 ] \qquad ( 15 )$$

$$M = [ \begin{matrix}A & B / 2 & D / 2 \\ B / 2 & C & E / 2 \\ D / 2 & E / 2 & F\end{matrix} ] \qquad ( 16 )$$

where X represents augmented coordinates.

It has been yet further found through research that for any elliptical region in an image, such as the entire region of the iris or pupil, after calculating M using the ellipse parameter of the elliptical region, the elliptical region may be represented by X^{T}MX, for example: when the coordinates (x, y) are used to represent a position of any pixel point in the image, if it is determined that X^{T}MX>0, then it can be determined that the pixel point is located inside the elliptical region; if it is determined that X^{T}MX=0, then it can be determined that the pixel point is located on the boundary of the elliptical region; or if it is determined that X^{T}MX<0, then it can be determined that the pixel point is located outside the elliptical region, so that the present disclosure can use formula (17) below to convert the ellipse parameter into a mask image, such as the mask image shown by the right image in FIG. 6.

$$G = {X}^{T} M X \qquad ( 17 )$$

where G is used to represent a position of the elliptical region on the image.

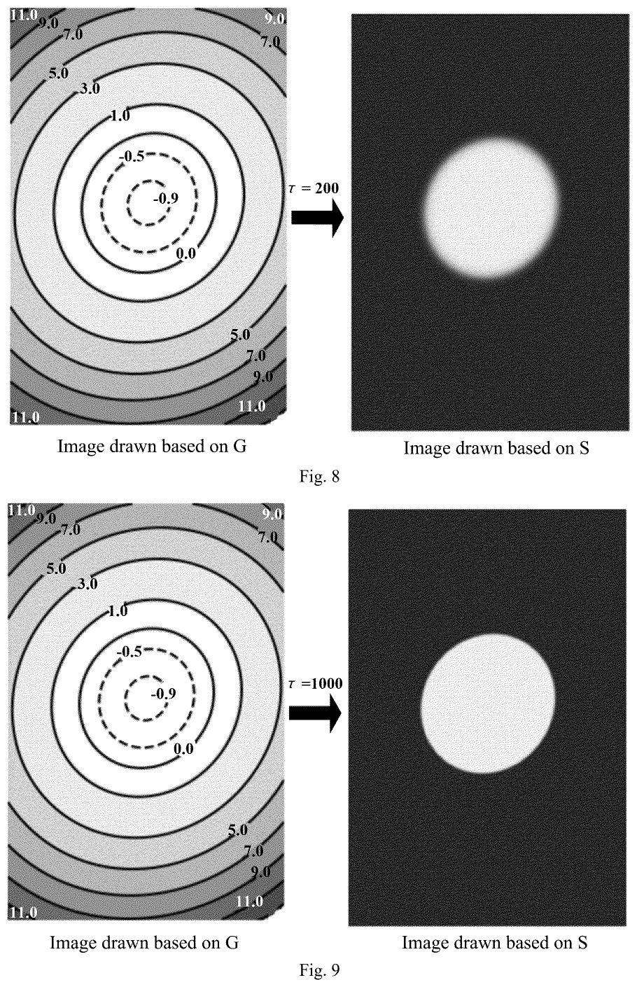

It has been further found through research that the value of X^{T}MX may fall within the interval [−1, +∞), so that each pixel value in G belongs to the interval [−1, +∞), which may cause some problems when using G directly as a segmented image. Therefore, in order to better improve the analysis effect, the following formula (18) may be used to process G, to obtain data S that can be used as a segmented image.

$$S = σ ( \frac{- G}{max ( G ) + δ} \times τ ) \qquad ( 18 )$$

where S is a mask image calculated based on an ellipse parameter of an ellipse, so that the mask image can better represent a position of a region circled by the ellipse in the image; σ( ) represents the Sigmoid function; τ is used to constrain a feathering degree of the boundary of the region circled by the ellipse, and images drawn based on different t are different, such as the three images shown in FIG. 7 to FIG. 9, so that a user may set the value of t based on the actual application scenario, to ensure that τ can meet mask image conversion requirements in the actual application scenario; and δ is a very small value set in advance based on the actual application scenario, and δ is used to prevent defects that might be caused when the denominator of the above formula (18) is 0.

As can be seen from the above research, in one possible implementation, in order to better improve the analysis effect, step 12 mentioned above may include: first, according to the conversion method presented in formula (6) to formula (18), processing the ellipse parameter of the entire region of the iris to obtain a segmented image of the entire region of the iris, so that the segmented image can represent the position of the entire region of the iris in the eye image; and then, determining, based on the segmented image, the predicted position, such as probability mask image and/or binary mask image, of the entire region of the iris, so that the predicted position can describe the position of the entire region of the iris in the eye image according to the mask image.

It should be noted that the present disclosure does not limit the implementation of the step of “determining, based on the segmented image, the predicted position of the entire region of the iris” in the preceding paragraph, for example, it may include: directly determining the segmented image as the predicted position of the entire region of the iris. For another example, it may alternatively include: processing the segmented image to obtain the predicted position (e.g., probability mask image) of the entire region of the iris, so that the predicted position can describe a likelihood that each pixel point in the eye image falls inside the entire region of the iris and/or a likelihood that the pixel point falls outside the entire region of the iris. For yet another example, it may alternatively include: processing the segmented image to obtain the predicted position (e.g., binary mask image) of the entire region of the iris, so that the predicted position can describe whether each pixel point in the eye image falls inside the entire region of the iris. In different scenarios, a corresponding implementation may be selected based on actual analysis requirements.

In addition, the present disclosure does not limit the implementation of step 12 mentioned above, for example, in the case where the eye image is processed by the target model, step 12 may be implemented using an iris parameter conversion network in the target model. The iris parameter conversion network is configured to convert the ellipse parameter of the entire region of the iris into the predicted position, such as probability mask image and/or binary mask image, of the entire region of the iris, so that the predicted position can describe the position of the entire region of the iris in the eye image according to the mask image. It should be noted that the present disclosure does not limit the implementation of the iris parameter conversion network.

Based on the content related to step 11 and step 12 mentioned above, in some scenarios, after the eye image is acquired, the feature extraction processing may first be performed on the eye image by the feature extraction module in the target model, to obtain the feature extraction result; then, the feature extraction result is processed by the iris parameter prediction network in the target model to obtain the ellipse parameter of the entire region of the iris, so that the ellipse parameter can describe the boundary position of the entire region of the iris; and finally, the ellipse parameter is processed by the iris parameter conversion network in the target model to obtain the predicted position, such as probability mask image and/or binary mask image, of the entire region of the iris, so that the predicted position can describe the position of the entire region of the iris in the eye image according to the mask image.

The predicted position of the entire region of the pupil is used to describe a position where the entire region of the pupil is predicted to be located in the eye image; and the present disclosure does not limit the implementation of the predicted position, for example, the predicted position is similar to the implementation of “the predicted position of the visible region of the eyeball” above. In one possible implementation, the predicted position of the entire region of the pupil may be implemented using the probability mask image and/or the binary mask image.

In addition, in order to better improve the accuracy of analysis, the present disclosure provides a way of determining the predicted position of the entire region of the pupil, in which the process of determining the predicted position of the entire region of the pupil may include step 21 and step 22 as follows.

Step 21: determining an ellipse parameter of the entire region of the pupil based on the feature extraction result of the eye image.

The ellipse parameter of the entire region of the pupil is used to describe an ellipse formed by the entire region of the pupil, such as the ellipse shown by the left image in FIG. 5 or the ellipse shown by the left image in FIG. 6, so that the ellipse parameter can represent a boundary position of the entire region of the pupil.

In addition, the present disclosure does not limit the implementation of step 21 mentioned above, for example, the implementation of step 21 is similar to the implementation of step 11 mentioned above.

Furthermore, in order to better improve accuracy, the present disclosure further provides one possible implementation of step 21 mentioned above, in which step 21 may include step 211 to step 214 as follows.

Step 211: determining the ellipse parameter of the entire region of the iris based on the feature extraction result of the eye image.

It should be noted that for the content related to step 211, reference can be made to the content related to step 11 mentioned above.

Step 212: determining a parameter of a minimum bounding square of the entire region of the iris based on the ellipse parameter of the entire region of the iris.

The minimum bounding square of the entire region of the iris refers to a square with the smallest area that can include the entire region of the iris, such as the minimum bounding square shown in FIG. 4.

In addition, for the minimum bounding square of the entire region of the iris, the parameter of the minimum bounding square is used to describe characteristics such as position and size that the minimum bounding square presents in the eye image.

Furthermore, the present disclosure does not limit the implementation of the parameter of the minimum bounding square above, for example, it may include position information and size information of the minimum bounding square. The position information of the minimum bounding square is used to describe a position of the minimum bounding square in the eye image; and the present disclosure does not limit the implementation of the position information, for example, it may be implemented using coordinates (x₁, y₁) of a position of the top left corner of the minimum bounding square in the eye image. The size information of the minimum bounding square is used to describe a size of the minimum bounding square, and the present disclosure does not limit the implementation of the size information, for example, it may be implemented using the side length s of the minimum bounding square.

Furthermore, the present disclosure does not limit the implementation of step 212 mentioned above, for example, it may be implemented using any existing or future method that can determine the parameter of the minimum bounding square of the ellipse based on the ellipse parameter.

It has been found through research that in order to improve accuracy, step 212 mentioned above may be implemented using formulas (19) to (23) below.

$${x}_{1} = {x}_{0 ( i )} - Δ w \qquad ( 19 )$$

$${y}_{1} = {y}_{0 ( i )} - Δ h \qquad ( 20 )$$

$$s = 2 \times max ( Δ w , Δ h ) \qquad ( 21 )$$

$$Δ w = \sqrt{{a}_{( i )}^{2} {cos}^{2} {θ}_{( i )} + {b}_{( i )}^{2} {sin}^{2} {θ}_{( i )}} \qquad ( 22 )$$

$$Δ h = \sqrt{{a}_{( i )}^{2} {sin}^{2} {θ}_{( i )} + {b}_{( i )}^{2} {cos}^{2} {θ}_{( i )}} \qquad ( 23 )$$

where (x₁, y₁) represents the coordinates of the position of the top left corner of the minimum bounding square of the entire region of the iris in the eye image; s represents the side length of the minimum bounding square.

Step 213: cropping a region image of the minimum bounding square from the eye image based on the parameter of the minimum bounding square, so that the region image can represent image information carried by a portion that is present in the eye image and circled by the minimum bounding square.

It should be noted that the present disclosure does not limit the implementation of step 213 mentioned above, for example, it may be implemented using any existing or future method that can perform a cropping processing on an image, such as by means of image matting.

Step 214: determining the ellipse parameter of the entire region of the pupil based on the region image of the minimum bounding square above.

It should be noted that the present disclosure does not limit the implementation of step 214, and for case of understanding, the following description is made in connection with two cases.

Case 1: in some scenarios, such as scenarios without size constraints, step 214 mentioned above may include: predicting the ellipse parameter of the entire region of the pupil based on the region image of the minimum bounding square above.

Case 2: in some scenarios, such as scenarios with size constraints, if the size of the region image of the minimum bounding square above is not equal to the preset image size, step 214 mentioned above may include: first performing a size adjustment processing on the region image to obtain an adjusted image, so that the size of the adjusted image is equal to the preset image size; then predicting the ellipse parameter of the entire region of the pupil based on the adjusted image. It should be noted that for the content related to the preset image size, reference can be made to the above.

It should be noted that the present disclosure does not limit the implementation of the prediction process described in the above two paragraphs, for example, it may be implemented by any network having a prediction function, such as a regression network or as the pupil parameter prediction network as shown in FIG. 4.

Furthermore, in order to better improve accuracy, the present disclosure further provides one possible implementation of step 214 mentioned above, in which step 214 may include step 2141 and step 2142 as follows.

Step 2141: predicting, based on the region image of the minimum bounding square above (or the adjusted image above), a relative parameter (\hat{x}₀₍ₚ₎, ŷ₀₍ₚ₎, â₍ₚ₎, \hat{b}₍ₚ₎, \hat{θ}₍ₚ₎) of the entire region of the pupil on the region image (or the adjusted image), so that the relative parameter can represent a relative position of the ellipse described by the entire region of the pupil in the region image (or the adjusted image). \hat{x}₀₍ₚ₎ is used to represent a ratio, such as a percentage, of the horizontal coordinate of the ellipse center of the ellipse to the side length s of the region image (or the adjusted image); ŷ₀₍ₚ₎ is used to represent a ratio of the vertical coordinate of the ellipse center of the ellipse to the side length s of the region image (or the adjusted image); â₍ₚ₎ is used to represent a ratio of the length of the semi-major axis of the ellipse to s/2; \hat{b}₍ₚ₎ is used to represent a ratio of the length of the semi-minor axis of the ellipse to s/2; and \hat{θ}₍ₚ₎ represents the relative rotation angle at which the ellipse is in the region image (or the adjusted image), such as the angle between the semi-major axis of the ellipse and the horizontal axis in the coordinate system of the region image (or the adjusted image), or the angle between the semi-minor axis of the ellipse and the horizontal axis in the coordinate system.

Step 2142: performing a coordinate system conversion processing on the relative parameter of the entire region of the pupil on the region image above (or the adjusted image) based on the parameter of the minimum bounding square above, to obtain the ellipse parameter (x₀₍ₚ₎, y₀₍ₚ₎, a₍ₚ₎, b₍ₚ₎, θ₍ₚ₎) of the entire region of the pupil, so that the ellipse parameter can represent the position of the ellipse described by the entire region of the pupil in the eye image.

It should be noted that the present disclosure does not limit the implementation of step 2142 mentioned above, for example, it may be implemented using any coordinate system conversion method.

It has been found through research that in order to better improve accuracy, step 2142 mentioned above may be implemented using formulas (24) to (28) below.

$${x}_{0 ( p )} = {\hat{x}}_{0 ( p )} \times s + {x}_{1} \qquad ( 24 )$$

$${y}_{0 ( p )} = {\hat{y}}_{0 ( p )} \times s + {y}_{1} \qquad ( 25 )$$

$${a}_{( p )} = ( {\hat{a}}_{( p )} + ε ) \times s / 2 \qquad ( 26 )$$

$${b}_{( p )} = ( {\hat{b}}_{( p )} + ε ) \times s / 2 \qquad ( 27 )$$

$${θ}_{( p )} = {\hat{θ}}_{( p )} \qquad ( 28 )$$

where x₀₍ₚ₎ represents the horizontal coordinate of the ellipse center of the ellipse described by the entire region of the pupil; s represents the side length of the minimum bounding square above; (x₁, y₁) represents coordinates of a position of the top left corner of the minimum bounding square in the eye image; \hat{x}₀₍ₚ₎ is used to represent a ratio, such as a percentage, of the horizontal coordinate of the ellipse center to the side length; y₀₍ₚ₎ represents the vertical coordinate of the ellipse center of the ellipse; ŷ₀₍ₚ₎ is used to represent a ratio, such as a percentage, of the vertical coordinate of the ellipse center to the side length; a₍ₚ₎ represents the length of the semi-major axis of the ellipse; â₍ₚ₎ is used to represent a ratio of the length of the semi-major axis of the ellipse to s/2; b₍ₚ₎ represents the length of the semi-minor axis of the ellipse; \hat{b}₍ₚ₎ is used to represent a ratio of the length of the semi-minor axis of the ellipse to s/2; for the content related to ε, reference can be made to the above; θ₍ₚ₎ is used to represents the rotation angle of the ellipse; and \hat{θ}₍ₚ₎ represents the relative rotation angle at which the ellipse is in the region image of the minimum bounding square (or the adjusted image above).

Based on the content related to step 2141 and step 2142 mentioned above, in some scenarios, after the region image of the minimum bounding square above or the adjusted image above is acquired, the relative parameter of the entire region of the pupil on the image may be predicted first based on the image, so that the relative parameter can represent some relative information, such as a ratio, of the entire region of the pupil relative to the minimum bounding square; and then, the ellipse parameter of the entire region of the pupil may be calculated based on the relative parameter and the parameter of the minimum bounding square, so that the ellipse parameter can represent the position of the ellipse described by the entire region of the pupil in the eye image.

Based on the content related to step 211 to step 214 mentioned above, in some scenarios, after the feature extraction result of the eye image is acquired, the ellipse parameter of the entire region of the iris may be determined first based on the feature extraction result, so that the ellipse parameter can represent the position of the ellipse described by the entire region of the iris in the eye image; second, the parameter of the minimum bounding square of the entire region of the iris is determined based on the ellipse parameter of the entire region of the iris, so that the parameter of the minimum bounding square can represent the position of the minimum bounding square in the eye image; then, the region image of the minimum bounding square is cropped from the eye image based on the parameter of the minimum bounding square, so that the region image can represent the image information carried by the portion that is present in the eye image and circled by the minimum bounding square; and finally, the ellipse parameter of the entire region of the pupil is determined based on the region image. The region image is mainly used to describe the entire region of the iris in the eye image, so that only reference is made to the image information described by the region image when analyzing the ellipse parameter of the entire region of the pupil based on the region image, which can effectively avoid interference caused by portions of the eye image other than those described by the region image, thereby being beneficial to improving accuracy.

In addition, in order to better improve accuracy, in the case where the eye image is processed by the target model, the ellipse parameter of the entire region of the pupil may be determined using the pupil parameter prediction network in the target model. The pupil parameter prediction network is configured to determine the ellipse parameter of the entire region of the pupil; and the present disclosure does not limit the implementation of the pupil parameter prediction network, and for case of understanding, the following description is made in connection with some examples.

When the implementation of step 21 mentioned above is similar to the implementation of step 11 mentioned above, the pupil parameter prediction network above may be configured to implement step 21. In one possible implementation, the pupil parameter prediction network may be configured to determine the ellipse parameter of the entire region of the pupil based on the feature extraction result of the eye image.

When step 21 mentioned above includes step 211 to step 214 mentioned above, the pupil parameter prediction network above may be configured to implement step 214. In one possible implementation, the pupil parameter prediction network may be configured to determine the ellipse parameter of the entire region of the pupil based on the region image of the minimum bounding square above or the adjusted image above.

It should be noted that, in the case where input data of the pupil parameter prediction network in the target model includes the region image of the minimum bounding square above (or the adjusted image above), the present disclosure does not limit the implementation of the target model, for example, the target model may further include a second processing module. The second processing module is configured to determine the region image (or the adjusted image) based on the ellipse parameter of the entire region of the iris, so that the second processing module can be configured to implement the related process presented above, such as any process for determining the region image or any process for determining the adjusted image. In addition, the present disclosure does not limit the implementation of the second processing module, for example, it may be implemented using any existing or future network or module that can implement the related process.

When step 21 mentioned above includes step 211 to step 214 mentioned above, and step 214 includes step 2141 and step 2142 mentioned above, the pupil parameter prediction network above may be configured to implement step 2141, and step 2142 is implemented using a third processing module in the target model.

In one possible implementation, for the target model, the pupil parameter prediction network in the target model may be configured to predict the relative parameter of the entire region of the pupil on the region image (or the adjusted image) based on the region image of the minimum bounding square above (or the adjusted image above); and the third processing module in the target model may be configured to perform a coordinate system conversion processing on the relative parameter based on the parameter of the minimum bounding square, to obtain the ellipse parameter of the entire region of the pupil.

Input data of the third processing module includes output data of the pupil parameter prediction network in the target model; and the third processing module is configured to process the output data according to the above formulas (24) to (28). It should be noted that the present disclosure does not limit the implementation of the third processing module, for example, it may be implemented using any existing or future network or module that can implement formulas (24) to (28).

Based on the content of the above three paragraphs, in some scenarios, if the output data of the pupil parameter prediction network in the target model is used to represent relative information, such as ratios, on the region image cropped from the eye image, the output data of the pupil parameter prediction network may be processed by the third processing module in the target model based on characteristics, such as position and size, of the region image in the eye image to obtain the ellipse parameter of the entire region of the pupil, so that the ellipse parameter can represent the position of the ellipse described by the entire region of the pupil in the eye image, which is beneficial to better improve the analysis effect.

Step 22: determining the predicted position of the entire region of the pupil based on the ellipse parameter of the entire region of the pupil.

It should be noted that the implementation of step 22 is similar to the implementation of step 12 mentioned above, which will not be repeated here for the sake of brevity.

In one possible implementation in which the eye image is processed by the target model, step 22 mentioned above may be implemented using the pupil parameter conversion network in the target model. The pupil parameter conversion network is configured to convert the ellipse parameter of the entire region of the pupil into the predicted position, such as probability mask image and/or binary mask image, of the entire region of the pupil, so that the predicted position can describe the position of the entire region of the pupil in the eye image according to the mask image. It should be noted that the present disclosure does not limit the implementation of the pupil parameter conversion network.

Based on the content related to step 21 and step 22 mentioned above, in some scenarios, after the eye image is acquired, the feature extraction processing may first be performed on the eye image by the feature extraction module in the target model, to obtain the feature extraction result; then, the ellipse parameter of the entire region of the pupil is determined by the pupil parameter prediction network in the target model based on the feature extraction result, so that the ellipse parameter can describe the boundary position of the entire region of the pupil; and finally, the ellipse parameter is processed by the pupil parameter conversion network in the target model to obtain the predicted position, such as probability mask image and/or binary mask image, of the entire region of the pupil, so that the predicted position can describe the position of the entire region of the pupil in the eye image according to the mask image.

In addition, the present disclosure does not limit the implementation of S2 mentioned above, for example, in order to better improve accuracy, in the case where the eye image is processed by the target model, S2 may be implemented using a second prediction module in the target model. Input data of the second prediction module includes the output data of the feature extraction module in the target model; and the second prediction module is configured to determine the predicted position of the entire region of the iris and the predicted position of the entire region of the pupil based on the input data, such as the feature extraction result of the eye image.

Furthermore, the present disclosure does not limit the implementation of the second prediction module above, for example, it may be implemented using the second prediction module shown in FIG. 3. For another example, it may be implemented using any existing or future detection head.

Moreover, in order to improve accuracy, the present disclosure further provides one possible implementation of the second prediction module above, in which the second prediction module may include an iris parameter prediction network, an iris parameter conversion network, a pupil parameter prediction network, and a pupil parameter conversion network. It should be noted that, for the content related to the networks, reference can be made to the above.

In one possible implementation, the iris parameter prediction network may be configured to predict the ellipse parameter of the entire region of the iris based on the feature extraction result of the eye image; the iris parameter conversion network may be configured to convert the ellipse parameter of the entire region of the iris into the predicted position of the entire region of the iris; the pupil parameter prediction network may be configured to determine the ellipse parameter of the entire region of the pupil based on the feature extraction result; and the pupil parameter conversion network may be configured to convert the ellipse parameter of the entire region of the pupil into the predicted position of the entire region of the pupil. It should be noted that, for implementations of the networks, reference can be made to the above.

Based on the content related to S2 mentioned above, in some scenarios, when the eye image is processed by the target model, after the feature extraction processing is performed on the eye image using the feature extraction module in the target model to obtain the feature extraction result of the eye image, the feature extraction result is processed by the first prediction module in the target model to obtain the predicted position of the visible region of the eyeball, and then the feature extraction result is processed by the second prediction module in the target model to obtain the predicted position of the entire region of the iris and the predicted position of the entire region of the pupil, so that other characteristics of the eye image can be further analyzed later based on the three positions.

S3: determining a predicted position of a visible region of the iris and a predicted position of a visible region of the pupil based on the predicted position of the visible region of the eyeball, the predicted position of the entire region of the iris and the predicted position of the entire region of pupil.

The predicted position of the visible region of the iris is used to describe a position where the visible region of the iris is predicted to be located in the eye image, so that the predicted position can represent a position of a portion of the iris described in the eye image that is not occluded by an eyelid.

It should be noted that the implementation of the predicted position of the visible region of the iris is similar to the implementation of the predicted position of the visible region of the eyeball, which will not be repeated here for the sake of brevity.

In one possible implementation, the predicted position of the visible region of the iris may include a probability mask image and/or a binary mask image, so that the predicted position can describe the position of the visible region of the iris in the eye image according to the mask image. The probability mask image is used to describe a probability (or likelihood) that each pixel point in the eye image belongs to the visible region of the iris. The binary mask image is used to describe whether each pixel point in the eye image belongs to the visible region of the iris; and the binary mask image is obtained by performing a certain processing (e.g., argmax processing) on the probability mask image.

In addition, the present disclosure does not limit the manner in which the predicted position of the visible region of the iris is acquired, for example, it may include: determining the predicted position of the visible region of the iris based on the predicted position of the visible region of the eyeball and the predicted position of the entire region of the iris, so that the region described by the predicted position of the visible region of the iris includes: the intersection between the region described by the predicted position of the visible region of the eyeball and the region described by the predicted position of the entire region of the iris.

In addition, the present disclosure does not limit the implementation of the step of “determining the predicted position of the visible region of the iris based on the predicted position of the visible region of the eyeball and the predicted position of the entire region of the iris” mentioned above.

It has been found through research that, based on some constraints inherent to the eye itself, such as the iris being independent of an eyelid, the eyelid occluding the iris and the occlusion of the eyelid affecting the shape of the visible region of the iris, it may be inferred that in any eye state, such as a partially closed state, information related to the visible region of the iris, such as position, probability and other information, may be regarded as a conditional joint result of corresponding information of the entire region of the iris and corresponding information of the visible region of the eyeball, such as the conditional joint result presented in formula (29) below.

$$p ( iris , eye ) = p ( iris \vert eye ) p ( eye ) = p ( iris ) p ( eye ) \qquad ( 29 )$$

where p(iris, eye) represents a conditional joint result, also called joint probability, of a probability of the entire region of the iris and a probability of the visible region of the eyeball; p(iris) represents the probability of the entire region of the iris; and p(eye) represents the probability of the visible region of the eyeball.

Based on the above research, in order to better improve accuracy, when the predicted positions involved in the present disclosure includes a probability mask image and/or a binary mask image, the predicted position of the visible region of the iris may be determined based on a product of the predicted position of the visible region of the eyeball and the predicted position of the entire region of the iris.

The predicted position of the visible region of the pupil is used to describe a position where the visible region of the pupil is predicted to be located in the eye image, so that the predicted position can represent the position of a portion of the pupil described in the eye image that is not occluded by the eyelid.

It should be noted that the implementation of the predicted position of the visible region of the pupil is similar to the implementation of the predicted position of the visible region of the eyeball, which will not be repeated here for the sake of brevity.

In one possible implementation, the predicted position of the visible region of the pupil may include a probability mask image and/or a binary mask image, so that the predicted position can describe the position of the visible region of the pupil in the eye image according to the mask image. The probability mask image is used to describe a probability (or likelihood) that each pixel point in the eye image belongs to the visible region of the pupil. The binary mask image is used to describe whether each pixel point in the eye image belongs to the visible region of the pupil; and the binary mask image is obtained by performing a certain processing (e.g., argmax processing) on the probability mask image.

In addition, the present disclosure does not limit the manner in which the predicted position of the visible region of the pupil is acquired, for example, it may include: determining the predicted position of the visible region of the pupil based on the predicted position of the visible region of the eyeball and the predicted position of the entire region of the pupil, so that the region described by the predicted position of the visible region of the pupil includes the intersection between the region described by the predicted position of the visible region of the eyeball and the region described by the predicted position of the entire region of the pupil.

In addition, the present disclosure does not limit the implementation of the step of “determining the predicted position of the visible region of the pupil based on the predicted position of the visible region of the eyeball and the predicted position of the entire region of the pupil” mentioned above.

It has been found through research that, based on some constraints inherent to the eye itself, such as the pupil being independent of the eyelid, the eyelid occluding the pupil and the occlusion of the eyelid affecting the shape of the visible region of the pupil, it may be inferred that in any eye state, such as a partially closed state, information related to the visible region of the pupil, such as position, probability and other information, may be regarded as a conditional joint result of corresponding information of the entire region of the pupil and corresponding information of the visible region of the eyeball, such as the conditional joint result presented in formula (30) below.

$$p ( pupil , eye ) = p ( pupil \vert eye ) p ( eye ) = p ( pupil ) p ( eye ) \qquad ( 30 )$$

where p(pupil, eye) represents a conditional joint result, also called joint probability, of a probability of the entire region of the pupil and a probability of the visible region of the eyeball; p(pupil) represents the probability of the entire region of the pupil; and p(eye) represents the probability of the visible region of the eyeball.

Based on the above research, in order to better improve accuracy, when the predicted positions involved in the present disclosure includes a probability mask image and/or a binary mask image, the predicted position of the visible region of the pupil may be determined based on a product of the predicted position of the visible region of the eyeball and the predicted position of the entire region of the pupil.

In addition, the present disclosure does not limit the implementation of S3 mentioned above, for example, in the case where the eye image is processed by the target model, S3 may be implemented using a conditional joint module in the target model. Input data of the conditional joint module includes output data of a first detection module in the target model and output data of a second detection module in the target model, so that the conditional joint module may be configured to determine the predicted position of the visible region of the iris and the predicted position of the visible region of the pupil based on the predicted position of the visible region of the eyeball, the predicted position of the entire region of the iris and the predicted position of the entire region of the pupil.

In addition, the present disclosure does not limit the implementation of the conditional joint module, for example, when the predicted positions involved in the present disclosure include a probability mask image and/or a binary mask image, the conditional joint module may be configured to multiply at least two mask images to achieve conditional joint processing.

Based on the content related to S1 to S3 mentioned above, for the image processing method according to the embodiment of the present disclosure, an eye image and a feature extraction result of the eye image are first acquired, so that the feature extraction result can represent information carried by the eye image; then a predicted position of a visible region of an eyeball, a predicted position of an entire region of an iris and a predicted position of an entire region of a pupil are determined based on the feature extraction result, so that the determination process satisfies at least a constraint, inherent to an eye itself, that the iris is independent of an eyelid and the pupil is independent of the eyelid; and then a predicted position of a visible region of the iris and a predicted position of a visible region of the pupil are determined based on the predicted position of the visible region of the eyeball, the predicted position of the entire region of the iris and the predicted position of the entire region of the pupil, so that the determination process at least satisfies two constraints, inherent to the eye itself, that the eyelid may occlude the iris and/or the pupil, and that the occlusion of the eyelid may affect the shape of the visible region of the iris and the shape of the visible region of the pupil. This enables analysis of the eye image while satisfying all the constraints inherent to the eye itself as much as possible, thus effectively avoiding defects caused by ignoring some of the constraints inherent to the eye itself, thereby being beneficial to improving accuracy.

In addition, the present disclosure does not limit the application scenarios of the image processing method above, for example, the image processing method may be used to implement an analysis task for an eye image. For another example, the image processing method may further be used to implement a training process for a target model, so that the trained target model has better analysis performance. To facilitate understanding, the following will provide explanations in conjunction with examples.

As an example, when the image processing method provided in the present disclosure is used to implement a training process for a target model, the image processing method may include step 31 to step 33 as follows.

Step 31: acquiring an eye image, and annotation information corresponding to the eye image, where the annotation information is used to describe an actual position of a visible region of an eyeball in the eye image, an actual position of a visible region of an iris in the eye image, and an actual position of a visible region of a pupil in the eye image.

The eye image refers to an image that needs to be analyzed in the current round; and the present disclosure does not limit the manner in which the eye image is acquired, for example, it may include: randomly selecting an image from a set of images as the eye image. The set of images refers to a set of images needed for model training; and each image in the set of images is used to describe at least an eye.

The annotation information corresponding to the eye image refers to ground truth information previously annotated for the eye image, so that the annotation information can describe eye characteristics actually described by the eye image, such as the actual position of the visible region of the eyeball in the eye image, the actual position of the visible region of the iris in the eye image, and the actual position of the visible region of the pupil in the eye image.

In addition, the present disclosure does not limit the manner in which the annotation information above is acquired, for example, in some scenarios, such as scenarios with high accuracy requirements, the annotation information may be manually annotated by relevant personnel.

For another example, in some scenarios, such as scenarios with low accuracy requirements, in order to reduce costs, the annotation information above may be a segmentation result obtained by segmenting the eye image, such as the annotation information shown in FIG. 4. The segmentation result is at least used to describe the position of the visible region of the eyeball in the eye image, the position of the visible region of the iris in the eye image, and the position of the visible region of the pupil in the eye image.

In addition, in order to minimize the difficulty of acquiring the annotation information as much as possible, the present disclosure further provides one possible implementation of the annotation information, in which the annotation information may include an annotated position of the visible region of the eyeball, an annotated position of the visible region of the iris and an annotated position of the visible region of the pupil, so that the annotation information describes only visible portions of the pupil and the iris, thus effectively overcoming defects caused by the annotation of the entire region of the pupil and the entire region of the iris, such as high annotation costs due to manual annotation only, and low accuracy due to manual annotation of invisible portions based on experience, which is beneficial to improving the prediction accuracy and stability of the entire region of the pupil and the entire region of the iris, while minimizing the difficulty of acquiring the annotation information as much as possible.

The annotated position of the visible region of the eyeball is used to describe a position where the visible region of the eyeball is actually located in the eye image; and the present disclosure does not limit the implementation of the annotated position, for example, it may be implemented using a probability mask image and/or a binary mask image.

The annotated position of the visible region of the iris is used to describe a position where the visible region of the iris is actually located in the eye image; and the present disclosure does not limit the implementation of the annotated position, for example, it may be implemented using a probability mask image and/or a binary mask image.

The annotated position of the visible region of the pupil is used to describe a position where the visible region of the pupil is actually located in the eye image; and the present disclosure does not limit the implementation of the annotated position, for example, it may be implemented using a probability mask image and/or a binary mask image.

Step 32: performing an analysis processing on the eye image using a target model, to obtain a predicted position of the visible region of the eyeball, a predicted position of the visible region of the iris, and a predicted position of the visible region of the pupil.

The target model is configured to perform an analysis processing on input data of the target model, such as the eye image, to obtain an analysis result, such as the predicted position of the visible region of the eyeball, a predicted position of the entire region of the iris, a predicted position of the entire region of the pupil, the predicted position of the visible region of the iris, and the predicted position of the visible region of the pupil.

In addition, the present disclosure does not limit the working principle of the target model, for example, as shown in FIG. 3, when the target model includes a feature extraction module, a first prediction module, a second prediction module and a conditional joint module, the feature extraction module is configured to perform a feature extraction processing on the eye image, to obtain a feature extraction result of the eye image; the first prediction module is configured to determine the predicted position of the visible region of the eyeball based on the feature extraction result; the second prediction module is configured to determine the predicted position of the entire region of the iris and the predicted position of the entire region of the pupil based on the feature extraction result; and the conditional joint module is configured to determine the predicted position of the visible region of the iris and the predicted position of the visible region of the pupil based on the predicted position of the visible region of the eyeball, the predicted position of the entire region of the iris and the predicted position of the entire region of the pupil. It should be noted that, for the content related to the respective modules, reference can be made to the above.

In one possible implementation, the second prediction module may include an iris parameter prediction network, an iris parameter conversion network, a pupil parameter prediction network, and a pupil parameter conversion network; the iris parameter prediction network is configured to predict an ellipse parameter of the entire region of the iris based on the feature extraction result; the iris parameter conversion network is configured to convert the ellipse parameter of the entire region of the iris into the predicted position of the entire region of the iris; the pupil parameter prediction network is configured to determine an ellipse parameter of the entire region of the pupil based on the feature extraction result; and the pupil parameter conversion network is configured to convert the ellipse parameter of the entire region of the pupil into the predicted position of the entire region of the pupil. It should be noted that, for the content related to the respective modules, reference can be made to the above.

Based on the content related to step 32 mentioned above, in some scenarios, when the target model includes the feature extraction module, the first prediction module, the second prediction module and the conditional joint module, after the eye image is input into the target model, a feature extraction processing is first performed on the eye image by the feature extraction module to obtain the feature extraction result of the eye image, so that the feature extraction result can represent information carried by the eye image; then the predicted position of the visible region of the eyeball is determined by the first prediction model based on the feature extraction result, and the predicted position of the entire region of the iris and the predicted position of the entire region of the pupil is determined by the second prediction module based on the feature extraction result; and then a conditional joint processing is performed on the three predicted positions by the conditional joint module, to obtain and output the predicted position of the visible region of the iris and the predicted position of the visible region of the pupil.

Step 33: updating the target model based on the predicted position of the visible region of the eyeball, the predicted position of the visible region of the iris, the predicted position of the visible region of the pupil, and the annotation information corresponding to the eye image, and returning to continue performing step 31 mentioned above and subsequent steps until a preset stop condition is satisfied.

The preset stop condition refers to a condition that needs to be satisfied when stopping model training; and the present disclosure does not limit the implementation of the preset stop condition, for example, the preset stop condition may include a model loss of the target model being below a preset loss threshold. For another example, the preset stop condition may include a rate of change of the model loss of the target model being below a preset rate of change threshold. For yet another example, the preset stop condition may include the number of updates to the target model reaching a preset threshold.

The model loss of the target model is used to represent the analysis performance of the target model; and the model loss is determined based on the predicted position of the visible region of the eyeball, the predicted position of the visible region of the iris, the predicted position of the visible region of the pupil, and the annotation information corresponding to the eye image. It should be noted that the present disclosure does not limit the manner in which the model loss is calculated and, for case of understanding, the following description is made in conjunction with examples.

As an example, when the annotation information corresponding to the eye image includes the annotated position of the visible region of the eyeball, the annotated position of the visible region of the iris and the annotated position of the visible region of the pupil, the process of determining the model loss of the target model includes step 331 to step 334 as follows.

Step 331: calculating a difference between the predicted position of the visible region of the eyeball and the annotated position of the visible region of the eyeball, to obtain a first difference, so that the first difference is used to describe a difference between the predicted position of the visible region of the eyeball and an actual position of the visible region of the eyeball, thereby enabling the first difference to represent the analysis performance that the target model presents on the visible region of the eyeball.

It should be noted that the present disclosure does not limit the implementation of step 331, for example, it may be implemented using any existing or future method for calculating position difference, such as any method that can calculate a difference between two mask images.

Step 332: calculating a difference between the predicted position of the visible region of the iris and the annotated position of the visible region of the iris, to obtain a second difference, so that the second difference is used to describe a difference between the predicted position of the visible region of the iris and an actual position of the visible region of the iris, thereby enabling the second difference to represent the analysis performance that the target model presents on the visible region of the iris. The predicted position of the visible region of the iris is obtained by further inference of the target model based on the predicted position of the entire region of the iris, so that the second difference can further represent the analysis performance that the target model presents on the entire region of the iris.

It should be noted that the present disclosure does not limit the implementation of step 332, for example, it may be implemented using any existing or future method for calculating position difference, such as any method that enables calculation of a difference between the two mask images.

Step 333: calculating a difference between the predicted position of the visible region of the pupil and the annotated position of the visible region of the pupil, to obtain a third difference, so that the third difference is used to describe a difference between the predicted position of the visible region of the pupil and an actual position of the visible region of the pupil, thereby enabling the third difference to represent the analysis performance that the target model presents on the visible region of the pupil. The predicted position of the visible region of the pupil is obtained by further inference of the target model based on the predicted position of the entire region of the pupil, so that the second difference can further represent the analysis performance that the target model presents on the entire region of the pupil.

It should be noted that the present disclosure does not limit the implementation of step 333, for example, it may be implemented using any existing or future method for calculating position difference, such as any method that enables calculation of a difference between two mask images.

It should further be noted that the present disclosure does not limit the relationship between the execution time of step 331, the execution time of step 332, and the execution time of step 333 mentioned above; for example, the three are the same; for another example, the three are different.

Step 334: determining the model loss of the target model based on the first difference, the second difference, and the third difference.

It should be noted that the present disclosure does not limit the implementation of step 334, for example, it may include performing summation of the first difference, the second difference, and the third difference, to obtain the model loss of the target model. For another example, it may include performing weighted summation of the first difference, the second difference, and the third difference, to obtain the model loss of the target model.

Based on the content related to step 331 to step 334 mentioned above, in some scenarios, the model loss of the target model may be determined based on the differences between the predicted positions and the actual positions of the visible regions, so that the model loss can at least represent the analysis performance of the target model for all eye characteristics.

In addition, in order to better improve efficiency, only some of the modules in the target model need to be updated. Based on this, when the target model includes the feature extraction module, the first prediction module, the second prediction module and the conditional joint module, and the second prediction module includes the iris parameter prediction network, the iris parameter conversion network, the pupil parameter prediction network and the pupil parameter conversion network, step 33 mentioned above may include: updating the feature extraction module, the first prediction module, the iris parameter prediction network and the pupil parameter prediction network in the target model based on the predicted position of the visible region of the eyeball, the predicted position of the visible region of the iris, the predicted position of the visible region of the pupil, and the annotation information corresponding to the eye image, and returning to continue performing step 31 mentioned above and subsequent steps, until the preset stop condition is satisfied.

Based on the content related to step 31 to step 33 mentioned above, for the training process of the target model, the annotation costs can be effectively reduced because only the ground truth position of the visible part of the pupil and the ground truth position of the visible part of the iris need to be annotated. Moreover, when the target model is trained under the guidance of the ground truth position of the visible part of the pupil and the ground truth position of the visible part of the iris, the target model can directly acquire the ellipse parameters of the entire region of the pupil and the entire region of the iris through constraints encoded in the model, such as constraints inherent to ellipse itself, constraints inherent to conditional segmentation itself, and constraints inherent to eye itself, so that the target model can not only predict the respective visible regions, but also predict the entire region of the pupil and the entire region of the iris under these constraints, which not only being beneficial to simplifying the analysis link for the eye image, but also being beneficial to improving the accuracy and stability of the prediction of the entire region of the pupil and the entire region of the iris, thereby being beneficial to better improve the analysis performance of the target model.

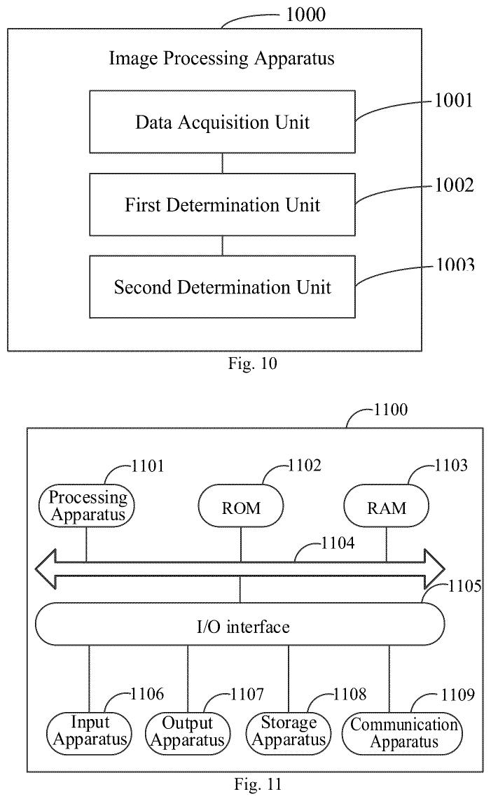

Based on the image processing method according to the embodiments of the present disclosure, the embodiments of the present disclosure further provide an image processing apparatus, which is explained and described below with reference to FIG. 10. FIG. 10 is a schematic diagram of a structure of an image processing apparatus provided by the embodiments of the present disclosure. It should be noted that, for the technical details of the image processing apparatus according to the embodiments of the present disclosure, reference can be made to the content related to the aforementioned image processing method.

As shown in FIG. 10, the image processing apparatus 1000 according to the embodiment of the present disclosure includes:
a data acquisition unit 1001 configured to acquire an eye image and a feature extraction result of the eye image;
a first determination unit 1002 configured to determine a predicted position of a visible region of an eyeball, a predicted position of an entire region of an iris and a predicted position of an entire region of a pupil based on the feature extraction result; and
a second determination unit 1003 configured to determine a predicted position of a visible region of the iris and a predicted position of a visible region of the pupil based on the predicted position of the visible region of the eyeball, the predicted position of the entire region of the iris and the predicted position of the entire region of the pupil.

In one possible implementation, the first determination unit 1002 is configured to: determine an ellipse parameter of the entire region of the iris based on the feature extraction result; and determine the predicted position of the entire region of the iris based on the ellipse parameter.

In one possible implementation, the first determination unit 1002 is configured to: determine an ellipse parameter of the entire region of the pupil based on the feature extraction result; and determine the predicted position of the entire region of the pupil based on the ellipse parameter.

In one possible implementation, the first determination unit 1002 is configured to: determine an ellipse parameter of the entire region of the iris based on the feature extraction result; determine a parameter of a minimum bounding square of the entire region of the iris based on the ellipse parameter of the entire region of the iris; crop a region image of the minimum bounding square from the eye image based on the parameter of the minimum bounding square; and determine the ellipse parameter of the entire region of the pupil based on the region image.

In one possible implementation, the eye image is processed by a target model; the target model includes a feature extraction module, a first prediction module, a second prediction module, and a conditional joint module; the feature extraction module is configured to perform a feature extraction processing on the eye image to obtain the feature extraction result; the first prediction module is configured to determine the predicted position of the visible region of the eyeball based on the feature extraction result; the second prediction module is configured to determine the predicted position of the entire region of the iris and the predicted position of the entire region of the pupil based on the feature extraction result; and the conditional joint module is configured to determine the predicted position of the visible region of the iris and the predicted position of the visible region of the pupil based on the predicted position of the visible region of the eyeball, the predicted position of the entire region of the iris and the predicted position of the entire region of the pupil.

In one possible implementation, the data acquisition unit 1001 is further configured to acquire annotation information corresponding to the eye image, and the annotation information is used to describe an actual position of the visible region of the eyeball in the eye image, an actual position of the visible region of the iris in the eye image, and an actual position of the visible region of the pupil in the eye image; and
the image processing apparatus 1000 further includes:
a model update unit configured to update the target model based on the predicted position of the visible region of the eyeball, the predicted position of the visible region of the iris, the predicted position of the visible region of the pupil, and the annotation information.

In one possible implementation, the annotation information includes an annotated position of the visible region of the eyeball, an annotated position of the visible region of the iris, and an annotated position of the visible region of the pupil;
the image processing apparatus 1000 further includes:
a loss determination unit configured to determine a model loss based on a difference between the predicted position of the visible region of the eyeball and the annotated position of the visible region of the eyeball, a difference between the predicted position of the visible region of the iris and the annotated position of the visible region of the iris, and a difference between the predicted position of the visible region of the pupil and the annotated position of the visible region of the pupil; and
the model update unit is configured to update the target model based on the model loss.

In one possible implementation, the second prediction module includes an iris parameter prediction network, an iris parameter conversion network, a pupil parameter prediction network, and a pupil parameter conversion network; the iris parameter prediction network is configured to predict an ellipse parameter of the entire region of the iris based on the feature extraction result; the iris parameter conversion network is configured to convert the ellipse parameter of the entire region of the iris into the predicted position of the entire region of the iris; the pupil parameter prediction network is configured to determine an ellipse parameter of the entire region of the pupil based on the feature extraction result; the pupil parameter conversion network is configured to convert the ellipse parameter of the entire region of the pupil into the predicted position of the entire region of the pupil; and
the model update unit is configured to update the feature extraction module, the first prediction module, the iris parameter prediction network and the pupil parameter prediction network in the target model.

In one possible implementation, the predicted position includes a probability mask image and/or a binary mask image.

In one possible implementation, the predicted position of the visible region of the pupil is determined based on a product of the predicted position of the visible region of the eyeball and the predicted position of the entire region of the pupil; and the predicted position of the visible region of the iris is obtained based on a product of the predicted position of the visible region of the eyeball and the predicted position of the entire region of the iris.

Based on the content related to the image processing apparatus 1000 described above, the working principle of the image processing apparatus 1000 provided in the present disclosure includes: first acquiring an eye image and a feature extraction result of the eye image, such that the feature extraction result can represent information carried by the eye image; then determining a predicted position of a visible region of an eyeball, a predicted position of an entire region of an iris and a predicted position of an entire region of a pupil based on the feature extraction result, so that the determination process satisfies at least a constraint, inherent to an eye itself, that the iris is independent of an eyelid and the pupil is independent of the eyelid; and then determining a predicted position of a visible region of the iris and a predicted position of a visible region of the pupil based on the predicted position of the visible region of the eyeball, the predicted position of the entire region of the iris and the predicted position of the entire region of the pupil, so that the determination process satisfies at least two constraints, inherent to the eye itself, that the eyelid may occlude the iris and/or the pupil, and that the occlusion of the eyelid may affect a shape of the visible region of the iris and a shape of the visible region of the pupil. This enables analysis of the eye image while satisfying all the constraints inherent to the eye itself as much as possible, thus effectively avoiding defects caused by ignoring some of the constraints inherent to the eye itself, thereby being beneficial to improving accuracy.

In addition, the embodiments of the present disclosure further provide an electronic device. The electronic device includes a processor and a memory. The memory is configured to store instructions or a computer program; and the processor is configured to execute the instructions or the computer program stored in the memory to enable the electronic device to perform any implementation of the image processing method according to the embodiments of the present disclosure.

Reference is made to FIG. 11, which is a schematic diagram of a structure of an electronic device 1100 suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 11 is merely an example, and shall not impose any limitation on the function and scope of use of the embodiments of the present disclosure.

As shown in FIG. 11, the electronic device 1100 may include a processing apparatus (e.g., a central processing unit or a graphics processing unit) 1101 that may perform a variety of appropriate actions and processing in accordance with a program stored in a read-only memory (ROM) 1102 or a program loaded from a storage apparatus 1108 into a random access memory (RAM) 1103. The RAM 1103 further stores various programs and data required for operations of the electronic device 1100. The processing apparatus 1101, the ROM 1102, and the RAM 1103 are connected to one another through a bus 1104. An input/output (I/O) interface 1105 is also connected to the bus 1104.

Generally, the following apparatuses may be connected to the I/O interface 1105: an input apparatus 1106 including, for example, a touchscreen, a touchpad, a keyboard, a mouse, a camera, a microphone, an accelerometer, and a gyroscope; an output apparatus 1107 including, for example, a liquid crystal display (LCD), a speaker, and a vibrator; the storage apparatus 1108 including, for example, a tape and a hard disk; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 1109, installed from the storage apparatus 1108, or installed from the ROM 1102. When the computer program is executed by the processing apparatus 1101, the above-mentioned functions defined in the method of the embodiment of the present disclosure are performed.

The electronic device provided by this embodiment of the present disclosure and the method provided by the above embodiments belong to the same inventive concept. For the technical details not exhaustively described in this embodiment, reference may be made to the above embodiments, and this embodiment and the above embodiments have the same beneficial effects.

The embodiments of the present disclosure further provide a computer-readable medium having instructions or a computer program stored therein which, when run on a device, enables the device to perform any implementation of the image processing method provided by the embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-mentioned computer-readable medium may be contained in the above-mentioned electronic device. Alternatively, the computer-readable medium may exist independently, without being assembled into the electronic device.

The above-mentioned computer-readable medium carries one or more programs that, when executed by the electronic device, enable the electronic device to perform the above-mentioned method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in the present disclosure are described in a progressive manner, and each embodiment focuses on the differences from other embodiments. The same or similar parts between the various embodiments may be referenced to each other. For the system or apparatus disclosed in this embodiment, because it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “include”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure is not limited to the embodiments described herein but is to be accorded with the broadest scope consistent with the principle and novel features disclosed herein.

1. An image processing method, comprising:
acquiring an eye image and a feature extraction result of the eye image;
determining a predicted position of a visible region of an eyeball, a predicted position of an entire region of an iris and a predicted position of an entire region of a pupil based on the feature extraction result; and
determining a predicted position of a visible region of the iris and a predicted position of a visible region of the pupil based on the predicted position of the visible region of the eyeball, the predicted position of the entire region of the iris and the predicted position of the entire region of the pupil.

2. The method according to claim 1, wherein determining the predicted position of the entire region of the iris comprises:
determining an ellipse parameter of the entire region of the iris based on the feature extraction result; and
determining the predicted position of the entire region of the iris based on the ellipse parameter.

3. The method according to claim 1, wherein determining the predicted position of the entire region of the pupil comprises:
determining an ellipse parameter of the entire region of the pupil based on the feature extraction result; and
determining the predicted position of the entire region of the pupil based on the ellipse parameter.

4. The method according to claim 3, wherein the determining the ellipse parameter of the entire region of the pupil comprises:
determining an ellipse parameter of the entire region of the iris based on the feature extraction result;
determining a parameter of a minimum bounding square of the entire region of the iris based on the ellipse parameter of the entire region of the iris;
cropping a region image of the minimum bounding square from the eye image based on the parameter of the minimum bounding square; and
determining the ellipse parameter of the entire region of the pupil based on the region image.

5. The method according to claim 1, wherein the eye image is processed by a target model;
the target model comprises a feature extraction module, a first prediction module, a second prediction module, and a conditional joint module;
the feature extraction module is configured to perform a feature extraction processing on the eye image to obtain the feature extraction result;
the first prediction module is configured to determine the predicted position of the visible region of the eyeball based on the feature extraction result;
the second prediction module is configured to determine the predicted position of the entire region of the iris and the predicted position of the entire region of the pupil based on the feature extraction result; and
the conditional joint module is configured to determine the predicted position of the visible region of the iris and the predicted position of the visible region of the pupil based on the predicted position of the visible region of the eyeball, the predicted position of the entire region of the iris and the predicted position of the entire region of the pupil.

6. The method according to claim 5, further comprising:
acquiring annotation information corresponding to the eye image, wherein the annotation information is used to describe an actual position of the visible region of the eyeball in the eye image, an actual position of the visible region of the iris in the eye image, and an actual position of the visible region of the pupil in the eye image; and
updating the target model based on the predicted position of the visible region of the eyeball, the predicted position of the visible region of the iris, the predicted position of the visible region of the pupil, and the annotation information.

7. The method according to claim 6, wherein the annotation information comprises an annotated position of the visible region of the eyeball, an annotated position of the visible region of the iris, and an annotated position of the visible region of the pupil;
the method further comprises:
determining a model loss based on a difference between the predicted position of the visible region of the eyeball and the annotated position of the visible region of the eyeball, a difference between the predicted position of the visible region of the iris and the annotated position of the visible region of the iris, and a difference between the predicted position of the visible region of the pupil and the annotated position of the visible region of the pupil; and
the updating the target model based on the predicted position of the visible region of the eyeball, the predicted position of the visible region of the iris, the predicted position of the visible region of the pupil, and the annotation information comprises:
updating the target model based on the model loss.

8. The method according to claim 6, wherein the second prediction module comprises an iris parameter prediction network, an iris parameter conversion network, a pupil parameter prediction network, and a pupil parameter conversion network;
the iris parameter prediction network is configured to predict an ellipse parameter of the entire region of the iris based on the feature extraction result;
the iris parameter conversion network is configured to convert the ellipse parameter of the entire region of the iris into the predicted position of the entire region of the iris;
the pupil parameter prediction network is configured to determine an ellipse parameter of the entire region of the pupil based on the feature extraction result;
the pupil parameter conversion network is configured to convert the ellipse parameter of the entire region of the pupil into the predicted position of the entire region of the pupil; and
the updating the target model comprises:
updating the feature extraction module, the first prediction module, the iris parameter prediction network and the pupil parameter prediction network in the target model.

9. The method according to claim 1, wherein the predicted position comprises a probability mask image and/or a binary mask image.

10. The method according to claim 9, wherein the predicted position of the visible region of the pupil is determined based on a product of the predicted position of the visible region of the eyeball and the predicted position of the entire region of the pupil; and
the predicted position of the visible region of the iris is obtained based on a product of the predicted position of the visible region of the eyeball and the predicted position of the entire region of the iris.

11. An electronic device, comprising a processor and a memory, wherein
the memory is configured to store instructions or a computer program; and
the processor is configured to execute the instructions or the computer program stored in the memory to enable the electronic device to perform an image processing method, and the image processing method comprises:
acquiring an eye image and a feature extraction result of the eye image;
determining a predicted position of a visible region of an eyeball, a predicted position of an entire region of an iris and a predicted position of an entire region of a pupil based on the feature extraction result; and
determining a predicted position of a visible region of the iris and a predicted position of a visible region of the pupil based on the predicted position of the visible region of the eyeball, the predicted position of the entire region of the iris and the predicted position of the entire region of the pupil.

12. The electronic device according to claim 11, wherein determining the predicted position of the entire region of the iris comprises:
determining an ellipse parameter of the entire region of the iris based on the feature extraction result; and
determining the predicted position of the entire region of the iris based on the ellipse parameter.

13. The electronic device according to claim 11, wherein determining the predicted position of the entire region of the pupil comprises:
determining an ellipse parameter of the entire region of the pupil based on the feature extraction result; and
determining the predicted position of the entire region of the pupil based on the ellipse parameter.

14. The electronic device according to claim 13, wherein the determining the ellipse parameter of the entire region of the pupil comprises:
determining an ellipse parameter of the entire region of the iris based on the feature extraction result;
determining a parameter of a minimum bounding square of the entire region of the iris based on the ellipse parameter of the entire region of the iris;
cropping a region image of the minimum bounding square from the eye image based on the parameter of the minimum bounding square; and
determining the ellipse parameter of the entire region of the pupil based on the region image.

15. The electronic device according to claim 11, wherein the eye image is processed by a target model;
the target model comprises a feature extraction module, a first prediction module, a second prediction module, and a conditional joint module;
the feature extraction module is configured to perform a feature extraction processing on the eye image to obtain the feature extraction result;
the first prediction module is configured to determine the predicted position of the visible region of the eyeball based on the feature extraction result;
the second prediction module is configured to determine the predicted position of the entire region of the iris and the predicted position of the entire region of the pupil based on the feature extraction result; and
the conditional joint module is configured to determine the predicted position of the visible region of the iris and the predicted position of the visible region of the pupil based on the predicted position of the visible region of the eyeball, the predicted position of the entire region of the iris and the predicted position of the entire region of the pupil.

16. The electronic device according to claim 15, wherein the image processing method further comprises:
acquiring annotation information corresponding to the eye image, wherein the annotation information is used to describe an actual position of the visible region of the eyeball in the eye image, an actual position of the visible region of the iris in the eye image, and an actual position of the visible region of the pupil in the eye image; and
updating the target model based on the predicted position of the visible region of the eyeball, the predicted position of the visible region of the iris, the predicted position of the visible region of the pupil, and the annotation information.

17. The electronic device according to claim 16, wherein the annotation information comprises an annotated position of the visible region of the eyeball, an annotated position of the visible region of the iris, and an annotated position of the visible region of the pupil;
the image processing method further comprises:
determining a model loss based on a difference between the predicted position of the visible region of the eyeball and the annotated position of the visible region of the eyeball, a difference between the predicted position of the visible region of the iris and the annotated position of the visible region of the iris, and a difference between the predicted position of the visible region of the pupil and the annotated position of the visible region of the pupil; and
the updating the target model based on the predicted position of the visible region of the eyeball, the predicted position of the visible region of the iris, the predicted position of the visible region of the pupil, and the annotation information comprises:
updating the target model based on the model loss.

18. The electronic device according to claim 16, wherein the second prediction module comprises an iris parameter prediction network, an iris parameter conversion network, a pupil parameter prediction network, and a pupil parameter conversion network;
the iris parameter prediction network is configured to predict an ellipse parameter of the entire region of the iris based on the feature extraction result;
the iris parameter conversion network is configured to convert the ellipse parameter of the entire region of the iris into the predicted position of the entire region of the iris;
the pupil parameter prediction network is configured to determine an ellipse parameter of the entire region of the pupil based on the feature extraction result;
the pupil parameter conversion network is configured to convert the ellipse parameter of the entire region of the pupil into the predicted position of the entire region of the pupil; and
the updating the target model comprises:
updating the feature extraction module, the first prediction module, the iris parameter prediction network and the pupil parameter prediction network in the target model.

19. The electronic device according to claim 11, wherein the predicted position comprises a probability mask image and/or a binary mask image.

20. A non-transitory computer-readable medium, storing instructions or a computer program, wherein the instructions or the computer program, when run on a device, enables the device to perform an image processing method, and the image processing method comprises:
acquiring an eye image and a feature extraction result of the eye image;
determining a predicted position of a visible region of an eyeball, a predicted position of an entire region of an iris and a predicted position of an entire region of a pupil based on the feature extraction result; and
determining a predicted position of a visible region of the iris and a predicted position of a visible region of the pupil based on the predicted position of the visible region of the eyeball, the predicted position of the entire region of the iris and the predicted position of the entire region of the pupil.
